(19) United States
(12) Patent Application Publication
(10) Pub. No.: US 2009/0133664 A1
(43) Pub. Date: May 28, 2009

(54) Extreme efficiency rotary engine

(76) Inventor: Robert Jackson Reid, San Diego, CA (US)

Correspondence Address: ROBERT J. REID, 10601 TIERRASANTA BLVD., #182, SAN DIEGO, CA, 92124, US

(21) Appl. No.: 12/002,238

(22) Filed: Dec. 13, 2007

Related U.S. Application Data
(60) Provisional application No. 60/874,853, filed on Dec. 14, 2006.

(51) Int. Cl. F02B 53/00

(52) U.S. Cl. 123/200

(57) ABSTRACT

This rotary engine configuration combines the four cycles required to produce power, thrust, exhaust, intake, and compression which are merged into a single cycle per revolution. Most engine designs need two revolutions. This requires the mechanical functions to produce power simultaneously; consequently, the parts are performing several functions at the same time. So, only a few parts are needed. The rotor is the big worker. Combustion turns the rotor power cog one way, while the exhaust gases go the opposite way to escape through an opening directly behind the power producing face, into the open air. In this concept, where many power generating functions are going on at the same time, only a few moving parts are needed. Fewer parts used translate into the many benefits described in the claims. An exhaust gas fan reduces the exhaust gas exit pressure further maximizing fuel economy. A kit of energy storing rings is provided. These rings can also provide pitch and roll stabilization forces for the vehicle.

### CROSS-REFERENCE TO RELATED APPLICATIONS

This application claims the benefit of provisional patent application Ser. No. 60/874,853, filed 2006 Dec. 14 by the present inventor.

### FEDERALLY SPONSORED RESEARCH

Non-applicable

### SEQUENCE LISTING OR PROGRAM

Non-applicable

### BACKGROUND OF THE INVENTION

1. Field of Invention

This invention pertains to maximizing gasoline engine fuel burning efficiency and user satisfaction, in particular, to rotary type engines.

2. Prior Art

I found no prior art indication that any rotary engine designs even approach the level of fuel burning efficiency that my invention will achieve. Also, I have not seen or heard about any write-ups or news releases which describe this configuration.

3. Objects and Advantages

The many objects and advantages over prior rotary engine art are listed below: My rotary engine is calculated to approximately double the fuel burning efficiency of any other engine by using far fewer parts and by using a never-before described thermo-dynamic power transfer medium:
(a) immense social benefit by reducing the cost of crude oil, reducing the amount of the “greenhouse” gas, CO₂, by approximately one half and markedly reducing owner's costs to own;
(b) this design has almost no friction so it can coast farther;
(c) this design does not need a cooling system nor does it use “crank-case” oil;
(d) it has reduced size, weight, cost to produce, and cost to repair;
(e) it has greatly increased reliability, reparability, and durability;
(f) it has excellent long-term marketing potential and requires only modest production tooling requirements, some of which exist in abandoned U.S. facilities;
(g) this engine will not be damaged by airborne ashes, sand, dirt, or other small particles;
(h) combustion gases exhaust fan is provided to further improve fuel consumption efficiency;
(i) a series of up to 5 “momentum rings” can be mounted to the outer rim of the fan. These rings will provide a means to store energy and also reduce vehicle pitch and roll motion;
(j) this engine will not need an exhaust pipe or muffler or anti-smog converter;
(k) cool exhaust gases will not make noise or cause fires.

### OBJECTS

All rotary type engines have difficulty delivering power to available drivable transmissions. I intend to submit a PPA within 90 days which will describe a new kind of transmission which will resolve this disadvantage. After submitting this PPA, I will inform the PTO regarding the “connection” between the two inventions.

### SUMMARY

This rotary engine has many unique features which will make it very valuable to society. The most important feature is that the normal 4 cycle engine has thrust, exhaust, intake and compression. The 4 cycles have been condensed into a single cycle design which yields power almost continuously and much more efficiently. The engine has very few moving parts, almost no friction, plus reduced size and weight compared to conventional piston-type engines. The engine does not require a cooling system, crankcase oil, exhaust pipe, muffler, or smog converter. An exhaust gas fan lowers the exit pressure of the exhausted gases which increases engine operating efficiency. An adjustable energy storing flywheel is provided.

### DRAWINGS

### Figures

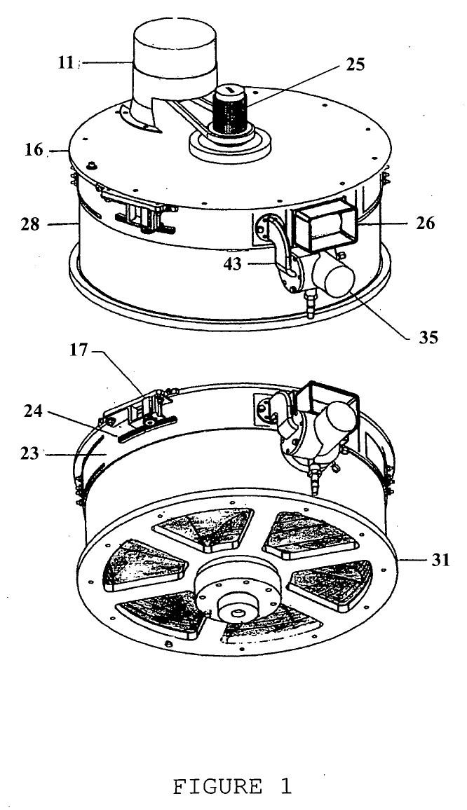

Description—FIGS. 1 through 5

In the drawings:

FIG. 1 shows the assembled extreme efficiency rotary engine top and bottom views.

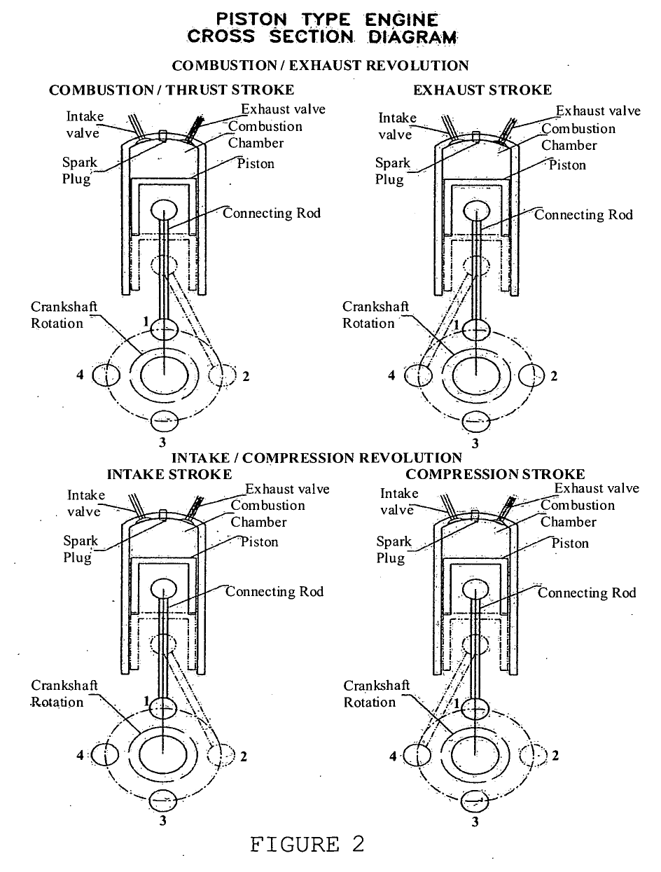

FIG. 2 illustrates the four-cycle, two revolution design used by piston-type engines (excepting two stroke engines which are very inefficient).

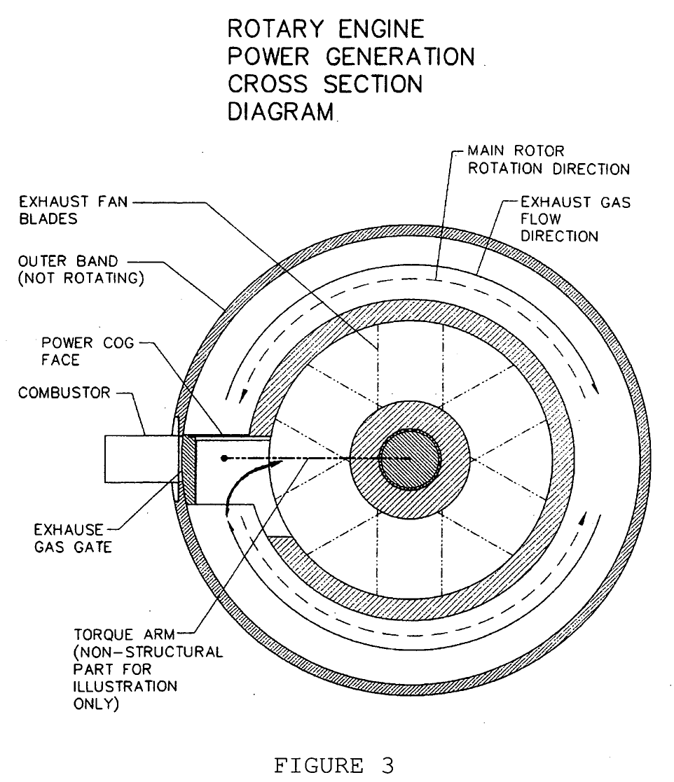

FIG. 3 shows a cross sectional illustration of the rotor function.

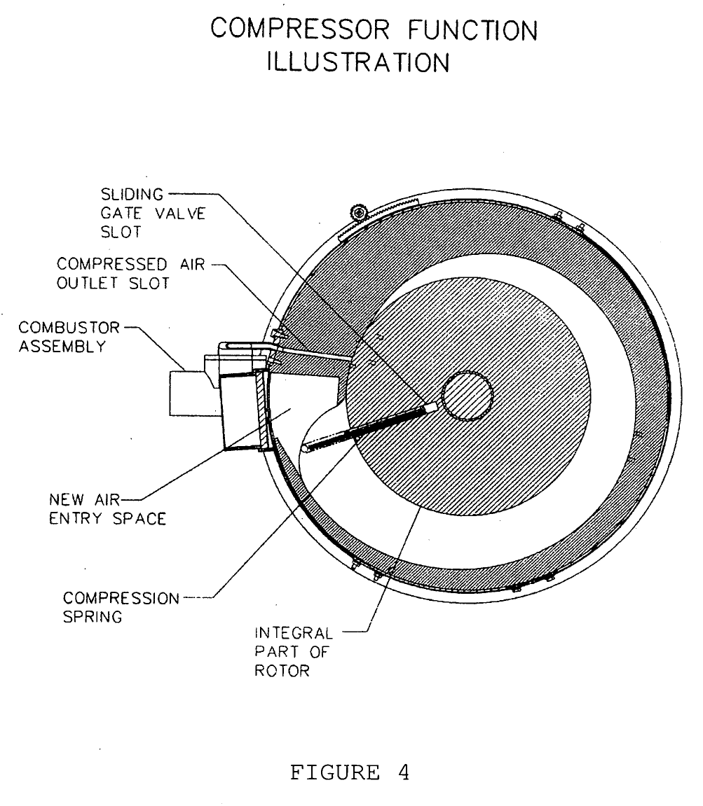

FIG. 4 illustrates a cross-sectional view of the intake air compressor.

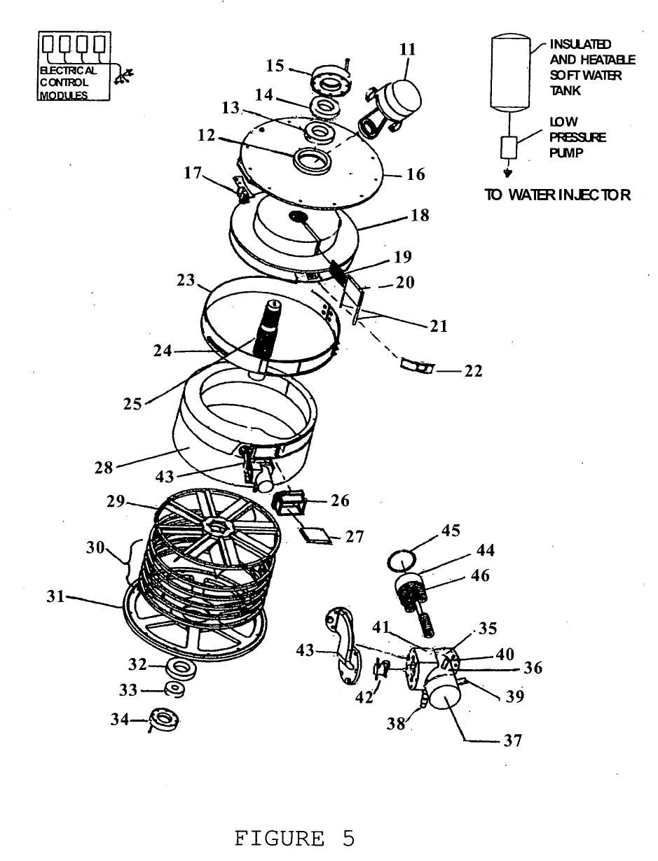

FIG. 5 shows an exploded view of the engine parts with corresponding reference numerals.

### DRAWINGS

### Reference Numerals

Two pages of reference numerals with part names are provided.

| | |
|---|---|
| 11 | Starter/Generator, Mounting V Bolt and 2 Pulleys Ref. FIG. 1 |
| 12 | Bearing Mount |
| 13 | Combination Thrust and Radial Bearing |
| 14 | Thrust Adjustment Fitting |
| 15 | Grease Seal |
| 16 | Structural Top Plate Ref. FIG. 1 |
| 17 | Reversible Stepping Motor Ref. FIG. 3 |
| 18 | One Piece Rotor Ref. FIG. 3 |
| 19 | Springs |
| 20 | Sliding Gate Valve |
| 21 | Constrained Rollers |
| 22 | Heat Distribution Plate |
| 23 | Rotating Air Intake Control Band Ref. FIG. 1 |
| 24 | Rack Gear To Stepping Motor Ref FIG. 1 |
| 25 | Power Shaft Ref. FIG. 1 |
| 26 | Air Intake Duct Ref FIG. 1 |
| 27 | Large Particle Filter |
| 28 | Structural Outer Band of Engine Ref. FIG. 1 |
| 29 | One Piece Welded Fan Belt Fan Hub to Rotor and Outer Rim Welded |
| | to Fan Blade Ends |
| 30 | Up to 5 Momentum Ring Kits to Be Bolted to the Fan Outer Rim |
| 31 | Bottom Structural Plate Ref. FIG. 1 |
| 32 | Radial Bearing |
| 33 | Thrust Bearing |
| 34 | Grease Seal and Bearing Retainer |
| 35 | Combustor Housing Ref. FIG. 1 |
| 36 | Combination Chamber (below dashed line) |
| 37 | Pressure Controller Piston Compression Section (above dashed line) |
| 38 | High Voltage Spark Plug |
| 39 | Water Injector |
| 40 | Fuel Injector |
| 41 | Compressed Air Intake Valve Housing Attachment |
| 42 | Compressed Air Intake Valve |
| 43 | Compressed Air Connector Ref. FIG. 1 |
| 44 | Combustion Pressure Regulator Cylinder |
| 45 | Internal Cylinder Motion Stop Ring (note the dashed line) |
| 46 | Compression Springs (inside the pressure regulation Cylinder) |

### DETAILED DESCRIPTION

### Preferred Embodiment

FIG. 1 combined with FIG. 5 and the parts list show explicit configuration details of the preferred model. Be it understood that there will be other useful applications of this engine which will need some dimensional configuration adjustments which the patent will permit unless “new art” is involved.

Operations—FIGS. 1 through 5 FIG. 2 is shown for illustration purposes only. Note that the power generating stroke is never at a 90° angle to the torque arm as illustrated in FIG. 3. Engines which do not do this will always be less efficient than those which do. Also note that the power generating stroke in FIG. 2 uses 180° of a two revolution design. This is very inefficient compared with the 345° power generating stroke in my single revolution power generating design. Note that torqueing power is being applied almost continuously. This means there is much more time for the energy that my engine develops to be used and not wasted by hot exhaust gases.

FIG. 2 shows energy absorbing friction loses where pistons rub against cylinder walls. Engine designs which require many moving parts generate more friction. My engine has only 5 moving parts with only one small friction generation part. That part is the sliding gate valve in the intake-air-compressor. The power generating rotor has approximately 0.0015 inches of clearance, thus no friction inducing physical contact is involved.

FIG. 3 illustrates how the exhaust gases flow to get to the exhaust opening just behind the power cog face. Since the exhaust cycle, the power/thrust cycle, the compression cycle, and the ignition cycle are all taking place the same revolution, my engine should be labeled a single cycle type engine.

When combustion temperature is at 2800° F. or above, polluting gases such as nitrous oxides are produced very quickly. My engine is designed to prevent combustion temperatures from getting even close to 2800° F. There are several design features which reduce combustion temperature by the soft water injection and by the compressed air pressure controller piston, (Part No. 37). Both reduce combustion temperatures concurrently with ignition.
(a) The soft water injector injects a prescribed amount of water into the combustion chamber at the same time the fuel is injected and the high voltage spark plug fires. The combustion produces a superheated mixture of super heated steam and combusted gases at a temperature well below 2800° F. The injected water absorbs the high heat energy.
(b) The resultant combusted gas temperature is proportional to the pressure of the compressed gases. When the air inlet opening into the compressor is wide open, the compressed air will be greater than normal or supercharged. The inlet air control band (Part No. 23) can be rotated by means of the stepping motor (Part No. 17) and rack gear (Part No. 24) to reduce the compressed air pressure to normal or lower. The resulting after combustion pressures and temperatures will then be much lower. By this means combustion air inlet pressure can be “tuned” or controlled thereby maximizing engine efficiency.
(c) For this aluminum engine design, it is necessary to keep the operating temperature at or below 500° F. Cylinder (Part No. 45) with compression springs (Part No. 46) inside the pressure regulating cylinder (Part No. 44) retracts back into the outer part of the combustor if the pressure rises above 500 pounds per square inch. Pressure and temperature are closely related in a closed space. Springs with the proper compression ratio must be selected to keep the temperature near 500° F.

FIG. 3 also shows the exhaust gas gate which is an integral part of the rotor. This part of the rotor closes off the combustion chamber for approximately 15° of rotation while combustion occurs.

FIG. 4 shows how the sliding gate valve, which is driven by the rotor, works to compress intake air.

FIG. 5 shows an exploded view of all of the engine parts with identifying part numbers.

Part No. 28 is a structural “flywheel” rim welded onto the outer fan blade tips and enables the mounting of up to 5 additional “flywheel” rings.

Part No. 29 is a one-piece part because the fan blades are welded to a center hub which is able to be bolted to the rotor.

Part No. 30 is a flywheel ring kit which includes five additional flywheel/momentum rings with appropriate length mounting bolts depending upon the number of rings desired.

All the rings store inertial energy which can be utilized to conserve breaking energy which can then be used to augment forward acceleration after stopping. Thus very little energy is lost during this energy conservation cycle. The number of rings used will normally depend upon the weight of the vehicle in which the engine is installed and the type of driving the vehicle owner does.

In addition to the fuel conservation benefit, the rings will provide “gyroscopic” pitch and roll stabilization. The amount of stabilization force will be greater the faster the rings are rotating. In many vehicles, the gyroscopic stabilization will improve rider comfort and sometimes added safety as well.

It is to be understood that the dimensions and configuration details described herein are flexible for different engine applications and will still be covered by this patent.

### SCOPE

The preferred model, just described has many more applications than in the automotive industry. These applications will need only dimensional adaptations to provide efficient power to vehicles on land such as: trucks, buses, RV's, military vehicles, construction equipment, stationary pumps, and farm equipment, etc.

On the sea this engine would be highly desirable because it would be immune to sea water corrosion. In the air this engine, because of its lighter weight, fuel economy and better reliability would provide better power for propeller installed aircraft.

Please take note of the Positive and Negative Factors Evaluation chart on the following pages. The huge positive total shows that the advantages far out value the shortcomings. Eventually these advantages will be enjoyed worldwide.

Positive and Negative Factors Evaluation
Inventor(s): Robert J. Reid: Invention
Extreme Fuel Efficiency Rotary Engine

| Factor | | Weight (−100 to +100) |
|---|---|---|
| 1. | Cost | (+30) |
| 2. | Weight | (+30) |
| 3. | Size | (+20) |
| 4. | Safety/Health | (+20) |
| 5. | Speed | 0 |
| 6. | Ease of Use | (+30) |
| 7. | Ease of Production | (+20) |
| 8. | Durability | (+50) |
| 9. | Repairability | (+50) |
| 10. | Novelty | 0 |
| 11. | Convenience/Social Benefit/Mechanization | (+100) |
| 12. | Reliability | (+40) |
| 13. | Ecology | (+80) |
| 14. | Salability | (+80) |
| 15. | Appearance | 0 |
| 16. | Viewability | 0 |
| 17. | Precusuib | 0 |
| 18. | Noise | (+20) |
| 19. | Odor | 0 |
| 20. | Taste | 0 |
| 21. | Market Size | (+80) |
| 22. | Trend of Demand | (+80) |
| 23. | Seasonal Demand | (+20) |
| 24. | Difficulty of Market Penetration | (+80) |
| 25. | Potential Competition | (+80) |
| 26. | Quality | (+20) |
| 27. | Excitement | (+50) |
| 28. | Markup | (+70) |
| 29. | Inferior Performance | (+50) |
| 30. | “Sexy Packaging | 0 |
| 31. | Miscellaneous | (+80) |
| 32. | Long Life Cycle | (+50) |
| 33. | Related Product Adaptability | (+30) |
| 34. | Satisfies Existing Need | (+100) |
| 35. | Legality | 0 |
| 36. | Operability | 0 |
| 37. | Development | (−20) |
| 38. | Profitability | (+80) |
| 39. | Obsolescence | (+50) |
| 40. | Incompatibility | (−80) |
| 41. | Product Liability Risk | 0 |
| 42. | Market Dependence | (+10) |
| 43. | Difficulty of Distribution | (+70) |
| 44. | Service Requirements | (+50) |
| 45. | New Tooling Required | (+30) |
| 46. | Inertia Must Be Overcome | (+30) |
| 47. | Too Advanced Technically | (+30) |
| 48. | Substantial Learning Required | 0 |
| 49. | Difficult to Promote | 0 |
| 51. | Crowded Field | 0 |
| 52. | Commodities | (+80) |
| 53. | Combination Products | 0 |
| 54. | Entrenched Competition | (+50) |
| 55. | Instant Anachronism | 0 |
| 56. | Prototype Availability | (−10) |
| 57. | Broad Patent Coverage Available | (+70) |
| 58. | High Sales Anticipated | (+70) |
| 59. | Visibility of Invention in Final Product | (+10) |
| 60. | Ease of Packaging | (+20) |

### CONCLUSION

One must conclude that the societal value of reduced crude oil consumption, reduced greenhouse gas emissions, elimination of smog, and the reduction in costs of equipment powered by this extremely efficient rotary engine are the “heavyweights.” The worth of these social benefits ultimately is beyond calculation. The world needs this invention!

I claim:

1. A single cycle rotary engine for powering—but not limited to—automobiles, where said rotary engine which comprises the following housing components, wherein said components being defined by a “Starter/Generator” mounted atop a “Structural Top Plate” with a “Reversible Stepping Motor” mounted on the outside wall of a “Rotating Air Intake Control Band” with a “Rack Gear” attached to the base of the “Reversible Stepping Motor” whereupon an “Air Intake Duct” is also mounted on the outside wall of the “Rotating Air Intake Control Band” below which is the “Structural Outer Band” of said engine, mounted to which is the “Combustor Housing” which is connected to the “Compressor Air Connector” below which and connected to the “Structural Outer Band” is the “Bottom Structural Plate” of said engine that will when properly constructed provide energy savings, lower carbon dioxide emission, minimal pollution emission, and lower consumer costs as compared with typical piston engines.

2. The rotary engine recited in claim 1 wherein substantial fuel savings is accomplished by incorporating a new power generating cycle by combining the power stroke with the exhaust stroke and the compression stroke and ignition, thereby greatly increasing the efficiency of said engine.

3. The rotary engine recited in claim 1 wherein much lower pollution (NOx) emission, which increases very rapidly at combustion temperatures above 2800° F., is brought down to less than 1400° F. where (NOx) does not form, because water is injected into said engine's combustion chamber just prior to ignition.

4. The rotary engine recited in claim 1 wherein lower consumer costs to operate said engine are the direct result of said engine's condensed configuration including: no cooling system, no crankcase oil, and no muffler or smog converter or smog pipe.

5. The rotary engine recited in claim 1 wherein additional fuel savings by said engine comprising low friction configuration advantages in that: said engine uses almost no energy-absorbing friction which allows it to coast farther on the highway; in addition, said engine will use very little fuel while idling, therefore said engine will use less fuel over time, thereby improving said engine's value to society.

6. The rotary engine recited in claim 1 wherein said engine provides immense social benefit by reducing the need for crude oil by approximately one half which will markedly reduce owner's costs to own and operate said engine.

7. The rotary engine recited in claim 1 wherein lowered CO₂, carbon dioxide engine emissions result directly from the lowered engine fuel usage by reducing the “greenhouse effect” caused by the release of carbon dioxide gas.

8. A single cycle rotary engine for powering—but not limited to—automobiles, where said rotary engine which comprises the following housing components, wherein said components being defined by a “Stafter/Generator” mounted atop a “Structural Top Plate” with a “Reversible Stepping Motor” mounted on the outside wall of a “Rotating Air Intake Control Band” with a “Rack Gear” attached to the base of the “Reversible Stepping Motor” whereupon an “Air Intake Duct” is also mounted on the outside wall of the “Rotating Air Intake Control Band” below which is the “Structural Outer Band” of said engine, mounted to which is the “Combustor Housing” which is connected to the “Compressor Air Connector” below which and connected to the “Structural Outer Band” is the “Bottom Structural Plate” of said engine that will when properly constructed provide valuable design features.

9. The rotary engine recited in claim 8 wherein said engine's configuration has valuable features which comprise the facility of said engine parts to be manufactured through current and available tooling which will expedite production of said engine, thus making it easier and cheaper to mass produce, thereby improving said engine's value to society.

10. The rotary engine recited in claim 8 wherein said engine has valuable physical dimensions comprising said engine's installation requirement for less volume thereby either allowing for a more compact vehicle or releasing space within the vehicle for other uses and said engine's inherent property of weighing less than a typical piston engine each results in more mileage per gallon of fuel used, thereby improving said engine's value to society.

11. The rotary engine recited in claim 8 wherein high reliability is made possible because said engine uses very few moving parts that can wear out.

12. The rotary engine recited in claim 8 wherein are additional valuable features of said engine which comprises the need for a lesser number and lower cost repairs given that said engine uses a small number of parts, hence said engine is expected to last for hundreds of thousands of miles, thereby improving said engine's value to society.

13. The rotary engine recited in claim 8 wherein said engine has a reduced size and weight which translates to a reduction in the costs to produce as compared to conventional piston-type engines today.

14. The rotary engine recited in claim 8 wherein unique features of said engine comprising the fact that said engine will not be damaged by airborne ashes, sand, dirt or other small particles because operating clearances are large enough to accommodate small particles without damage to said engine together with the fact that said engine will make almost no noise because the exhaust fan reduces exhaust gas pressures to very low levels and said engine will waste little to no exhaust heat energy and will start no fires because exhaust gases are cooled by the exhaust fan thereby improving said engine's value to society.

15. The rotary engine recited in claim 8 wherein said engine's exhaust fan improves the efficiency and value of said engine by reducing exhaust gas pressures to near or sometimes below ambient to maximize said engine's power generation efficiency, while the fan configuration provides an energy storing outer rim thereby maximizing said engine's efficiency and improving value to owners.

16. The rotary engine recited in claim 8 wherein an installed inertial energy ring kit is a means to conserve and use inertial energy economically through angular radial momentum and to provide pitch and roll stabilization forces which will improve rider comfort and safety, thereby increasing said engine's value to owners.

17. A single cycle rotary engine for powering—but not limited to—automobiles, which comprises a “Reversible Stepping Motor” and uses a “Rack Gear” to rotate the “Air Intake Control. Band” around the “Power Shaft,” with said “Air Intake Control Band” being a narrow band which rotates outside said engine's “Air Compressor” so that as said “Air Intake Control Band's” opening is completely aligned with the opening into said “Air Compressor,” wherein maximum air pressure to the “Combustor Housing” occurs resulting that when said “Air Intake Control Band” rotates, the opening size is reduced because of misalignment which in turn lowers air pressure provided to said “Combustor Housing,” whereupon combustion takes place in said “Combustor Housing” with the resulting pressure being temporarily sealed off from entering the “Power Generating Rotor Channel” by the “Exhaust Gas Gate” which is rotating simultaneously with the “One Piece Rotor” allowing the high pressure generated by combustion to enter said “Power Generating Rotor Channel” causing said pressure to build up in front of the “Power Cog Face,” wherein said pressure, multiplied by the area of said “Power Cog Face” times the effective length of the “Torque Arm,” generates horsepower power which continues to be generated so long as there is a pressure differential between said “Power Cog Face” and the atmospheric pressure outside said engine, resulting that pressure is released through said “Power Generating Rotor Channel” as the exhaust gases escape through the opening directly behind said “Power Cog Face” to provide the energy necessary to propel the vehicle.

18. The rotary engine recited in claim 16 wherein said engine has greatly improved reliability, repairability, and durability compared to all other engines of equal horsepower available today.

19. The rotary engine recited in claim 16 wherein said engine is relatively immune from sea water corrosion translates into longer engine life for a sea going vessel.

20. The rotary engine recited in claim 16 wherein said engine, because of its lighter weight, fuel economy and better reliability can thereby provide better power for propeller installed aircraft.
